(19) United States
(12) Patent Application Publication
(10) Pub. No.: US 2014/0020650 A1
(43) Pub. Date: Jan. 23, 2014

(54) COMPOSITE MATERIAL HAVING STAMPING AND MICRO-PERFORATION

(71) Applicants: Klaus Schmitt, Grunebach (DE); Markus Löhr, Herdorf (DE)

(72) Inventors: Klaus Schmitt, Grunebach (DE); Markus Löhr, Herdorf (DE)

(21) Appl. No.: 14/007,310

(22) PCT Filed: Dec. 13, 2011
(86) PCT No.: PCT/EP11/72592

§ 371 Date: Sep. 24, 2013

(30) Foreign Application Priority Data
Mar. 25, 2011 (DE) 10 2011 006 145.2

(51) Int. Cl. F02B 77/11

(52) U.S. Cl. CPC F02B 77/11
USPC 123/198 R; 29/428

(57) ABSTRACT

A method includes the steps of providing a first panel of aluminium material; providing a second panel of steel material; stamping a plurality of first pimple-like bulges in the first panel; stamping a plurality of second pimple-like bulges in the second panel, wherein the arrangement of the second pimple-like bulges is congruent with the arrangement of the first pimple-like bulges; bringing together the sides of the first and second panels that are furnished with the bulges, so that the domes of each set of pimple-like bulges lie opposite each other; and clipping the first and second panels together to form a composite by ensuring that at least one tongue is broken out of each of the pimple-like bulges on the second panel and pressed into the corresponding pimple-like bulges in the first panel.

The invention relates to a novel composite material, particularly for heat shields, and a manufacturing method therefor. It further relates to a heat shield made with the novel composite material.

Heat shields for thermal shielding of exhaust systems as part of internal combustion engines for example are often manufactured from multiple heat-resistant metal and fibre materials. The manufacture of these composite materials is usually very complicated and associated with high costs. The direct material costs for the heat resistant fibre materials are also substantial.

Heat shields made from fibre and metal materials are also very difficult to recycle. Besides providing thermal shielding, perforated fibre materials with steel panels also help to lower noise levels close to the engine. The manufacture of such heat shields involves several work steps. Every effort is made to keep the weight of the shielding panels to a minimum. Aluminium heat shields can only be used for temperatures up to 400° C., however.

According to one aspect of the invention, a method is provided that comprises:
providing a first panel of aluminium material;
providing a second panel of steel material;
stamping a plurality of first pimple-like bulges in the first panel;
stamping a plurality of second pimple-like bulges in the second panel, wherein the arrangement of the second pimple-like bulges is congruent with the arrangement of the first pimple-like bulges;
bringing together the sides of the first and second panels that are furnished with the bulges, so that the domes of each set of pimple-like bulges lie opposite each other; and
clipping the first and second panels together to form a composite by ensuring that at least one tongue is broken out of each of the pimple-like bulges on the second panel and pressed into the corresponding pimple-like bulges in the first panel.

The present invention constitutes a novel heat shield consisting of two different materials. It is made from an aluminium material on one side and a heat-resistant steel or stainless steel material on the other. According to the invention, the two materials are joined to one another by mechanical clipping.

Special pimples are stamped into both the aluminium panel and the steel panel before the panels are clipped together. The arrangements of the first and second set of pimples match one another and they are congruent, that is to say the distance between the pimples and positions thereof on the material panels are identical.

When the panels with the stamped pimples are brought together, the sides on which the pimples are raised are facing one another so that the raised surfaces or domes of the respective pimples abut each other. The clipping is then carried out approximately in the middle of each pimple by pressing a part of the raised surface of the second pimples, in the steel panel, into the facing raised surface of the corresponding first pimples. In this way, a solid connection is created whereby the panels are joined and parallel to one another.

The provision of the pimples and the manner in which the pimples are joined creates cavities between the inner sides of the panels of the composite panel created thereby. The air-filled cavities support the insulating effect and also help to minimise the weight thereof, while the pimple structure and clipping forms a very rigid composite. The domes of the pimples are located opposite each other and thus form a shielding element filled with air as an insulator that serves to maintain a separation between the two panels in the composite.

According to one embodiment, the method further includes:
cutting a predetermined shape out of the composite.

As an alternative to pre-cut panels, according to this embodiment a desired heat shield shape may be cut out even after the clipping.

According to one embodiment, the method further includes:
flattening the edge of the composite so that the edge is closed off from the outside.

Not only are the edges flattened thereby, but the air chambers formed between the panels are also sealed off. The edge of the material is flattened to a width of about 1 mm-3 mm. No cavity between the two layers remains open to the outside.

According to one embodiment, the method further includes:
shaping the composite to obtain a predefined three-dimensional shape.

In this way, the heat shield is given a desired three-dimensional form so that it ideally shaped to surround parts of an exhaust system, for example.

According to one embodiment, at least three tongues are broken out from each bulge in the second panel and pressed into the corresponding bulge in the first panel.

The extra tongues help to improve the quality of the join. For example, type of clip may be created in the steel panel by means of a hole punch with a three- or four-sided ground profile that is pressed into the aluminium material from the steel panel side.

According to one embodiment, the pimple-like bulges have a hexagonal geometry.

The contour of the pimples in the aluminium material has a hexagonal geometry that is produced with hexagonal punches and a hexagonal stencil. The stencil also has a hexagonal profile for producing the pimple geometry in the steel panel.

According to one embodiment, a perforation is created when the pimples are punched and/or when the first and second panels are clipped together.

In this embodiment, the stamp is designed such that the material is torn inwards at the centre of the stencil hexagon during the stamping operation. This tearing is intentional and serves to lower the noise level. The tear may occur at 3 or 6 points of the pimples for example.

According to one embodiment, clipping takes place substantially in the middle of the bulge domes.

According to a further aspect of the invention, a shielding element manufactured according to a method described above is provided.

### BRIEF DESCRIPTION OF THE DRAWING

FIG. 1 shows a 3D view of a punched bulge according to an embodiment of the invention;

FIG. 2 shows a 3D view of another punched bulge according to an embodiment of the invention;

FIG. 3 shows a cross section of an embodiment of the clipping according to the invention;

FIG. 4 shows a cross section of a composite material according to the invention.

### DETAILED DESCRIPTION OF THE INVENTION

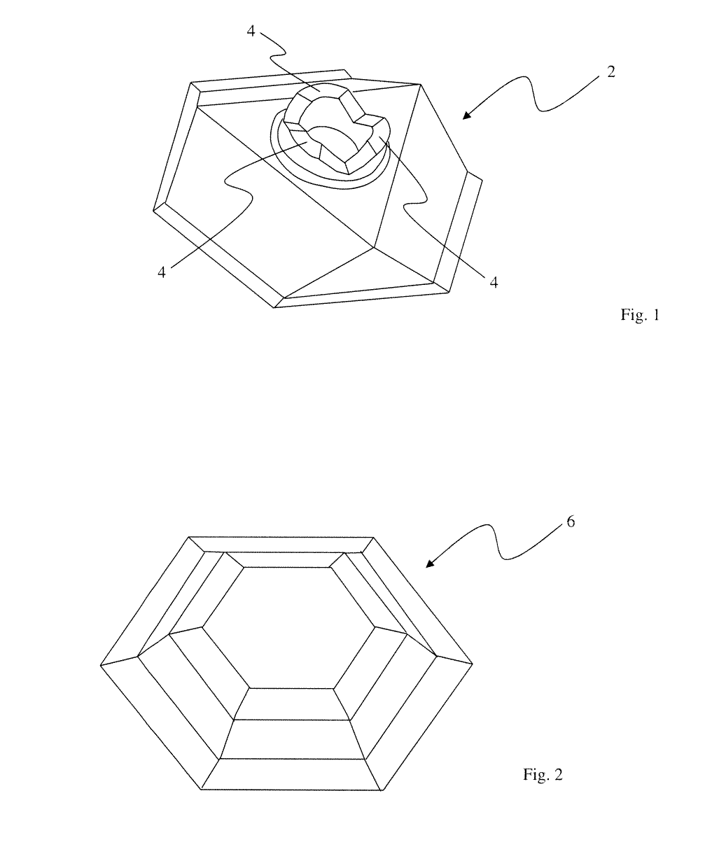

FIG. 1 shows a pimple-like bulge or punched profile 2 according to one embodiment. The punched profile 2 shown here is intended for use in the steel panel. It has a hexagonal geometry and hexagonal base. The tongues (three in this embodiment) are visible and are broken out of the panel by a hole punch, for example. In other embodiments, the number and also the shape of the tongues may vary.

FIG. 2 shows a pimple-like bulge or punched profile 6 according to one embodiment that is intended for use in the aluminium panel. This also has a hexagonal geometry.

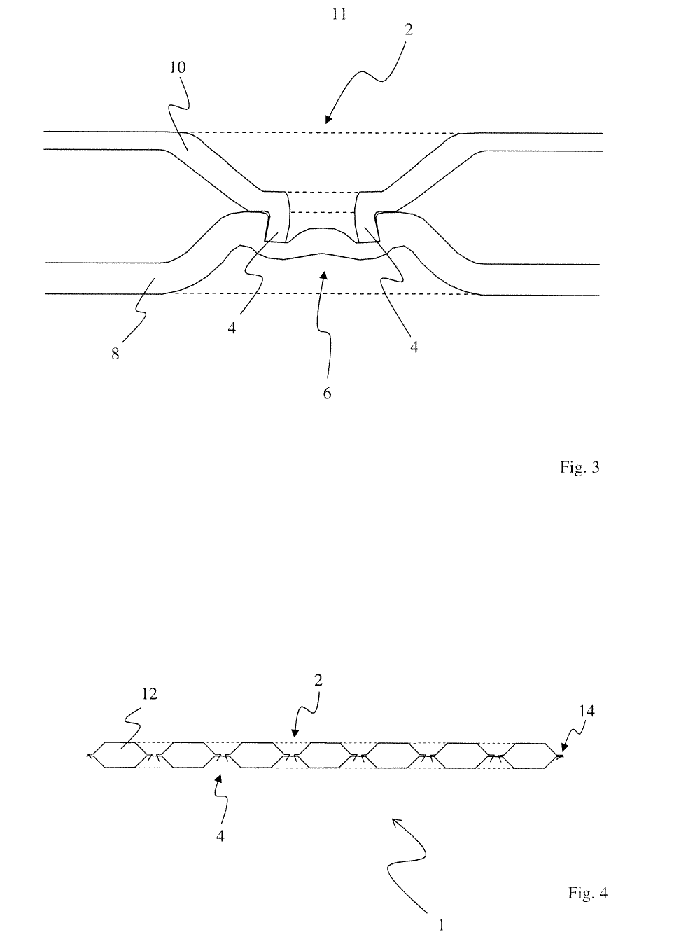

FIG. 3 shows a cross-section through a clipping point of a composite material according to the invention. In this case, lower panel 8 is the aluminium panel in which a plurality of pimple-like bulges 6, such as those of FIG. 2 for example, have been punched before clipping. Upper panel 10 in this case is the steel panel, in which a plurality of pimple-like bulges 2, such as those of FIG. 1 for example, were punched before clipping.

Panels 8 and 10 were then brought together in such manner that the domes of the respective bulges were lying opposite each other. At least one tongue 4 per bulge 2 is then broken out in the steel panel, two tongues 4 being visible in FIG. 3. These tongues 4 are pressed into the opposite bulge 6 in the aluminium panel to clip the two panels 8 and 10 together.

FIG. 4 shows a cross-section through a clipped composite panel 1. Cavities 12 are formed between the panels, the pimples serving as spacing elements between the panels. The pimples also serve to stiffen and thus stabilise the panels. The composite panel is flattened at the edges 14.

The invention offers the following advantages:
A reduction in the noise level is obtained through the use of different materials of different material thicknesses, the formation of air-filled cavities and the microperforation;
Production of the heat shield material is possible in a single work operation;

Additional materials for use as spacing elements or insulators are not needed;
Dispensing with the need for insulating materials simplifies recycling, for example, because it is much easier to separate the panels than to remove a fibre insulation and the like;
The formation of cavities results in a lightweight heat shield;
The heat shield is stiffened by the stamping (pimples) and is thus rendered very stable.

1. A method comprising:
providing a first panel of aluminium material;
providing a second panel of steel material;
stamping a plurality of first pimple-like bulges in the first panel;
stamping a plurality of second pimple-like bulges in the second panel, wherein the arrangement of the second pimple-like bulges is congruent with the arrangement of the first pimple-like bulges;
bringing together the sides of the first and second panels that are furnished with the bulges, so that the domes of each set of pimple-like bulges lie opposite each other; and
clipping the first and second panels together to form a composite by ensuring that at least one tongue is broken out of each of the pimple-like bulges on the second panel and pressed into the corresponding pimple-like bulges in the first panel.

2. The method according to claim 1, further comprising:
cutting a predetermined shape out of the composite.

3. The method according to claim 1, further comprising:
flattening the edge of the composite so that the edge is closed off from the outside.

4. The method according to claim 1, further comprising:
shaping the composite to obtain a predefined three-dimensional shape.

5. The method according to claim 1, wherein at least three tongues are broken out from each bulge in the second panel and pressed into the corresponding bulge in the first panel.

6. The method according to claim 1, wherein the pimple-like bulges have a hexagonal geometry.

7. The method according to claim 1, wherein a perforation is created when the pimple-like bulges are punched and/or when the first and second panels are clipped together.

8. The method according to claim 1, wherein the clipping takes place substantially in the middle of the domes of the pimple-like bulges.

9. A shielding element manufactured in accordance with the method of claim 1.
